(19) United States
(12) Patent Application Publication
(10) Pub. No.: US 2016/0335605 A1
(43) Pub. Date: Nov. 17, 2016

(54) Automated System for Remote Personal Meetings

(71) Applicant: Avigdor Tessler, Houston, TX (US)

(72) Inventor: Avigdor Tessler, Houston, TX (US)

(21) Appl. No.: 15/151,818

(22) Filed: May 11, 2016

Related U.S. Application Data
(60) Provisional application No. 62/159,412, filed on May 11, 2015.

(51) Int. Cl. G06Q 10/10; H04L 12/58

(52) U.S. Cl. CPC G06Q 10/1095; H04L 51/04; G06Q 50/12

(57) ABSTRACT

Provided are systems for setting up business related virtual meetings such as breakfast, lunch or dinner meetings. The system comprises one or more computers having at least a processor, memory and display coupled to the processor and at least one network connection. A computer tool is coupled to the one or more computers. This interactive tool comprises an locating tool for extracting information of restaurants and their menus in an area, a plurality of modules configured to process and track information for setting up a virtual meeting, processing food orders and generating reminders. The interactive tool also comprises a database for lead and sales information, which is accessible via the modules. A user interface is integrated in the one or more computers and coupled to the modules and databases. The system is able to increase the acceptance rate of a meeting invitation and reduce the non-participation rate after acceptance.

### CROSS-REFERENCE TO RELATED APPLICATIONS

This non-provisional application claims benefit of priority under 35 U.S.C. §119(e) of provisional application U.S. Ser. No. 62/159,412, filed May 11, 2015, the entirety of which is hereby incorporated by reference.

### BACKGROUND OF THE INVENTION

1. Field of the Invention

The present invention relates to the field of remote and virtual sales systems. More specifically, the present invention relates to an online system for organizing a remote meeting accommodated by a meal, such as a lunch or dinner meeting, via the Internet.

2. Description of the Related Art

Breakfast, lunch and/or dinner meetings have been essential events in the traditional business world. Especially, for a sales person, lunch/dinner meetings directly provide a personal environment in which to engage prospective clients, to understand or even to increase the prospect's commitment levels. With the development of communication technologies, however, sales calls and on-line conferences are gradually replacing traditional lunch and/or dinner meetings.

While these calls and on-line conferences save time and traveling cost for both clients and sales agents, it loses the same personal touch as lunch and/or dinner meetings. Consequently, the initial acceptance rate or final turn up rate of an online conference can be significantly lower. Furthermore, these missed conferences inevitably hinders sales agents from accurately measuring qualified opportunities, win rates, and deal sizes, resulting in challenges in reading sales cycle lengths.

Therefore, there is a recognized need for an online conference system and method that sets up a lunch or dinner meeting-like environment for sales agents and multiple potential clients to increase personal engagement during a virtual business meeting and ultimately increase acceptance rate, final turn up rate and sales success rate. Particularly, the prior art is deficient in this aspect. The present invention fulfills this long-standing need and desire in the art.

### SUMMARY OF THE INVENTION

The present invention is directed to a system for a virtual breakfast, lunch or dinner business meeting. The system comprises one or more computers having at least a processor, memory and display coupled to the processor and at least one network connection. An interactive tool is coupled to the one or more computers. This interactive tool comprises an locating tool for extracting information of restaurants and their menus in an area, a plurality of modules configured to process and track information for setting up a virtual meeting, processing food orders and generating reminders. The interactive tool also comprises a database for lead and sales information, which is accessible via the modules. A user interface is integrated in the one or more computers and coupled to the modules and databases.

The present invention also is directed to a method for increasing an acceptance rate for invitations to a virtual business meeting. The method comprises accessing the system described herein. An initial email invitation is generated via the system to one or more prospective clients where the invitation comprises a proposed date and time for the virtual business meeting, a description for free food provided during the meeting and a quick response link to the invitation. The invitation email is sent to one or more prospect clients. The email invitation with a rescheduled date and time is resent for rescheduling the meeting if the initial invitation is declined.

The present invention is directed further to a method for reducing a non-participation rate in a virtual business meeting after acceptance of an invitation to attend. The method comprises accessing the system described herein. An acceptance of an initial email invitation is received from one or more prospective clients or invitees. The initial email invitation comprises a proposed date and time for the virtual business meeting, a description of food available during the meeting at no cost to the client, and a quick response link. A food order form or link is sent to each of the clients after receiving the acceptance. A final reminder email, which comprises a food order from the client, a delivery location, a meeting time, and a quick response button or link for final confirmation of attendance, is sent to the client before placing the food order. The food delivery is ordered for the meeting after the client confirms attendance at the meeting no later than the morning of the meeting day. Then, the virtual business meeting is launched via the system. The present invention is directed to a related method further comprising processing a transaction for the food order, depositing available credit for the food order and generating a log for transactions.

The present invention is directed further still to a user-implemented method for conducting a meeting, such as a sales lunch or dinner meeting, with a client. The method comprises the step of implementing the interactive tool as described supra. The user then contacts one or more clients to schedule an online lunch or dinner meeting via the interactive tool. Food is ordered online for delivery to the clients prior to a scheduled meeting time if a final reminder email before the meeting is accepted. The online sales lunch or dinner meeting is then launched with food served. The present invention is directed to a related method further comprising generating a report for said meeting, performing data analysis on the sales information related to said meeting and generating follow-up emails from a set of templates for setting up follow-up activity for the sales lead. The present invention is directed to other related methods further comprising one or more steps of recording the online meeting, rescheduling the sales meeting if the client is unable to meet at the scheduled time, predicting a sales cycle for the sales lead related to the online meeting based on the data analysis, and synchronizing the sales information between computers.

Other and further aspects, features, and advantages of the present invention will be apparent from the following description of the presently preferred embodiments of the invention given for the purpose of disclosure.

### BRIEF DESCRIPTION OF THE DRAWINGS

So that the matter in which the above-recited features, advantages and objects of the invention, as well as others that will become clear, are attained and can be understood in detail, more particular descriptions of the invention briefly summarized above may be by reference to certain embodiments thereof that are illustrated in the appended drawings. These drawings form a part of the specification. It is to be noted, however, that the appended drawings illustrate preferred embodiments of the invention and therefore are not to be considered limiting in their scope.

FIG. 1 is a schematic chart showing each component integrated in the online meeting system.

FIG. 2 is a schematic chart showing the overall process of setting up a lunch or dinner business meeting using the online meeting system.

FIG. 3 is a flowchart of detailed steps for setting up a lunch or dinner meeting using the online meeting system.

FIG. 4 is a screenshot of the user interface of the system showing a window of sending an email invitation.

FIG. 5 is a screenshot of the user interface of the system showing a window of the food ordering module.

FIG. 6 is a screenshot of the user interface of the system showing a window of the results of data analysis for the invitations and meetings conducted through the online meeting system.

### DETAILED DESCRIPTION OF THE INVENTION

As used herein in the specification, “a” or “an” may mean one or more. As used herein in the claim(s), when used in conjunction with the word “comprising”, the words “a” or “an” may mean one or more than one.

As used herein “another” or “other” may mean at least a second or more of the same or different claim element or components thereof. Similarly, the word “or” is intended to include “and” unless the context clearly indicates otherwise. “Comprise” means “include.”

As used herein, the term “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In some instances, the term “about” may include numerical values that are rounded to the nearest significant figure.

As used herein, the terms “remote personal meeting”, “virtual business meeting”, “virtual meeting”, “online business meeting”, “online meeting”, and “meeting” all refer to a meeting between parties via an electronic device that is accommodated with food delivered to the meeting parties for breakfast, lunch or dinner.

As used herein, the term “sales opportunity” refers to a potential customer who has been qualified as interested in a certain product, service or technology and typically will be associated with the “Opportunities” section in companies' sales management and CRM systems.

As used herein, the term “opportunities engagement” refers to the response of a sales prospect by phone, e-mail or any other social media platform such as, but not limited to LinkedIn.

As used herein, the term “no show rate” refers to a prospect that clicked on the “Accept” button of a webinar invitation e-mail but failed or declined to attend.

As used herein, the term “pipeline accurate measurement” refers to measurement reflecting only top sales opportunities.

In one embodiment of the present invention, there is provided a system for a virtual breakfast, lunch or dinner business meeting, comprising one or more computers having at least a processor, a memory and a display coupled to the processor and at least one network connection; and an interactive tool coupled to the one or more computers comprising a locating tool for extracting information of restaurants and menus thereof in an area; a plurality of modules configured to process and track information for setting up a virtual meeting, processing food orders and generating reminders; a database for lead and sales information accessible via the modules; a user interface integrated in the one or more computers coupled to the modules and databases.

In this embodiment, the computer may be a personal computer, a server computer, a smart phone or a tablet computer or any personal device with connection to a database. Also, the interactive tool may be further configured to generate and send customized email invitation and information forms to clients. In this embodiment, the sales information may comprise location, type of sales, client's information, meeting report for each sale or a combination thereof.

In addition in this embodiment, the interactive tool modules may be configured to create a customized email invitation comprising a description of a lunch or dinner meeting and information with paid food, and information forms based on a template tangibly stored in the interactive tool modules configured to increase an acceptance rate of the invitation; send the customized email invitation and information forms to a potential client; store sales information for rejected and accepted email invitations in a report for invitation results; send a thank-you email comprising links for rescheduling the meeting to a client that rejects the invitation email; locate restaurant menus in an area of a client that accepts the email invitation; generate a menu option form for the meeting for a client that accepts the email invitation; process information for meeting time; set up reminders for the meeting with the client that accepts the email invitation; send a meeting reminder to the client; track a response to the meeting reminder; order food on the ordering form if the response to the meeting reminder is positive; send a thank-you letter after the meeting; generate logs for food orders and a meeting summary in the database; reschedule the meeting if the response to the meeting reminder is negative; and synchronize the sales information between or among the computers.

Furthermore in this embodiment, the interactive tool modules may be configured to generate a survey form for the client and collect completed survey form. Further still, the interactive tool modules may be configured to enter and sort all the sales information and meeting information in the database. Further still, the interactive tool modules may be further configured to analyze the sales information and predict a sale cycle for each sale lead. Further still, the interactive tool modules may be configured for a user to search the database for the sales information.

Preferably, in this embodiment the user interface may comprise a set of best practices module configured to access meeting invitation templates, follow up templates, reminder templates and alert templates; a search module configured to locate sales information from the computers; a schedule module configured to schedule meetings and book time; a report module configured to provide report and overview sales information; a menu searching module configured for a user to collect information of restaurant menus around a designated area; a food ordering module for a client user to enter food order for the meeting; and a transaction module configured to deposit and spend money in the system for food ordering. The user interface may further comprise a recording module for recording the meeting. The user interface may further comprise a data analysis module configured for the user to conduct quantitative analysis on sales information and predict sales cycle for each sales lead.

In another embodiment of the present invention, there is provided a method for increasing an acceptance rate of invitations to a virtual business meeting, comprising the steps of accessing the system described supra; generating via the system an initial email invitation to one or more prospective clients comprising a proposed date and time for the virtual business meeting, a description of food available during the meeting at no cost to the client, and a quick response link; sending the initial email invitation to the one or more prospective clients; and resending the email invitation with a rescheduled date and time for rescheduling the meeting if the initial invitation is declined.

In this embodiment, the step of generating an initial email invitation may comprise user-searching the database for sales information or a sales lead that meets a set of criteria; and producing the email invitation for the virtual meeting based on a selected sales lead or sales information.

In yet another embodiment of the present invention, there is provided a method for reducing a non-participation rate in a virtual business meeting after acceptance of an invitation to attend, comprising the steps of accessing the system as described supra; receiving from one or more prospective clients or invitees an acceptance of an initial email invitation comprising a proposed date and time for the virtual business meeting, a description of food available during the meeting at no cost to the client, and a quick response link; sending a food order form or link to each of the clients after receiving the acceptance; sending a final reminder email comprising a food order from the client, a delivery location, a meeting time, and a quick response link for final confirmation of attendance before placing the food order; ordering the food on the order form for delivery for the meeting after the client confirms attendance at the meeting no later than the morning of the meeting day; and launching the virtual business meeting. Further to this embodiment, the method may comprise processing a transaction for the food order; depositing available credit for the food order; and generating a log for transactions.

In yet another embodiment of the present invention, there is provided a user-implemented method for conducting a virtual breakfast, lunch or dinner business meeting with client, comprising the steps of implementing the interactive tool comprising the system as described supra; contacting one or more clients to schedule an online lunch or dinner meeting; ordering food online for delivery to the client prior to a scheduled meeting time if a final reminder email before the meeting is accepted; and launching the virtual sales lunch or dinner meeting.

Further to this embodiment, the method comprises the steps of generating a report for the meeting; performing data analysis on the sales information related to the meeting and generating one or more follow-up emails to the client from a set of templates for setting up follow-up activities for the sales lead. In this further embodiment the follow up email may comprise a follow-up to the client for a re-meeting, for reminding a sales agent to follow-up with the client, or a combination thereof. Further still, the method comprises recording the virtual business meeting. Further still, the method comprises rescheduling the virtual business meeting if the client is unable to meet at the scheduled time. Further still, the method comprises predicting a sales cycle for the sales lead related to the virtual business meeting based on said data analysis. Further still, the method comprises synchronizing the sales information between the computers.

In all embodiments, the step of contacting the client may comprise user-searching the database for sales information or sales lead that meet a set of criteria; generating an email invitation for a virtual business meeting based on a selected sales lead or sales information; sending a final reminder email to the client before a scheduled meeting time; and rescheduling the meeting if the reminder email is declined by the client.

Also in all embodiments, the email invitation may comprise a link for a quick response for the client; a description of a free lunch or dinner meeting for the client configured to increase an acceptance rate and reduce the no show rate for the meeting; and a link for scheduling a meeting time.

In addition in all embodiments, the step of ordering the food delivery may comprise locating restaurant menus within a designated area for the user and the client if the email invitation is accepted; generating an order form of selected restaurants for the client; receiving the order form from the client; and ordering food on the order form for the virtual meeting if the client confirms attendance via the final reminder email. Further to this embodiment, the method comprises processing a transaction for food orders; depositing available credit for food orders and generating a log for transactions.

Furthermore in all embodiments, the step of locating restaurant menus comprises conducting a search for restaurant menus using a third-party software or website; and extracting restaurant menus from search results of the third-party software or website.

In yet another embodiment of the present invention, there is provided a non-transitory machine-readable storage medium comprising processor executable instructions for performing the user-implemented method as described supra.

Provided herein are systems for setting up virtual lunch or dinner meetings. Generally, this system may be used for business purposes, especially in the field of sales. Overall, the system comprises one or more computers having at least a processor, a memory and display coupled to the processor and at least one network connection. Further, an interactive tool is coupled to the one or more computers. The interactive tool comprises a locating tool for extracting information of restaurants and menus thereof in an area, a plurality of modules configured to process and track information for setting up a virtual business meeting, processing food orders and generating reminders, a database for sales leads and sales information and a user interface integrated in the computers, modules and database.

Overall, the interactive tool comprises a plurality of modules. In non-limiting examples the modules may comprise a set of best practices for different processes that are commonly experienced in the sales world such as, but not limited to, meeting invitation templates, follow-up templates, reminder templates and alert templates, which are commonly considered in the art as best practices towards achieving the highest success level of conversion from a sales opportunity in to closing a sale. The interactive tool may comprise one or more of a search module, a schedule module, a report module, a menu-searching module, a food-ordering module, a transaction module, a recording module, and a data analysis module. Particularly, a search module enables users to locate sales information and sales leads. The schedule module is used to automatically locate time slots and book meeting time on a calendar. Further, the schedule module creates reminders before and on the meeting days, such as on the day before the meeting but no later than the morning of the meeting day. The report module is configured to generate a report for each meeting and an overview of sales information. The menu searching module is configured to enable a user to collect information of restaurant menus in a designated area, e.g. a zip code area. The food-ordering module is configured to automatically place food orders for the users (sales agents) and clients. The transaction module is configured to enable the deposit of and spending of credits in the system for the expense of food ordered for the lunch or dinner meetings. The recording module in the system is used for recording each meeting. The data analysis module is configured to enable users (sales agents or companies) to conduct data analysis on sales information, meeting expenses, and to allow prediction of a sales cycle for each sales lead.

Embodiments of the present invention are better illustrated with reference to the Figure(s), however, such reference is not meant to limit the present invention in any fashion.

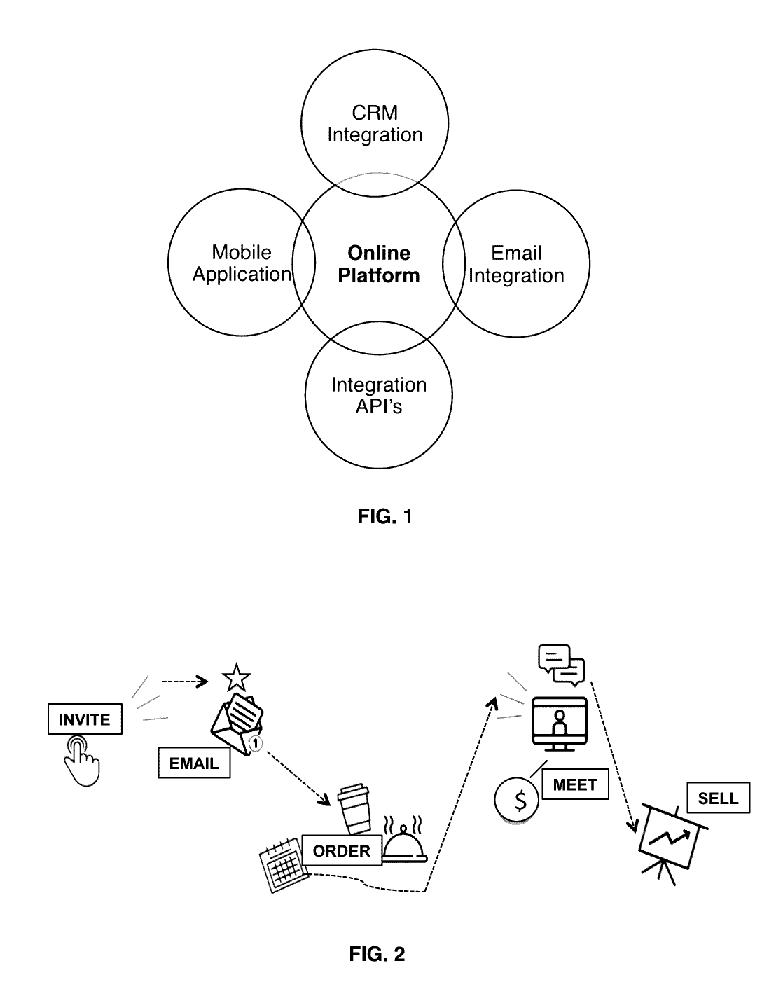

FIG. 1 illustrates how the system integrates customer relationship management (CRM), mobile application, email apps, and the Application programming interface (API). For example, Open Talk™ may be used for the video conference; MailGun™ may be used for the email function of the system; HighCharts™ may provide the statistics dashboard for the system. For the food ordering and delivering function, the website Delivery.com may be used.

FIG. 2 illustrates that the overall process of setting up a virtual business meeting, such as a breakfast, lunch or dinner meeting, starts with a user (sales agent) sending an email invitation to a client. When the invitation is accepted, an order form for food from a local restaurant is sent to the client. The system orders the food for the meeting. This online breakfast, lunch or dinner meeting provides a personal environment for the sales agent and client to discuss sales and consequently offers more accurate information regarding the clients and potentially increases the chance for a sales agreement.

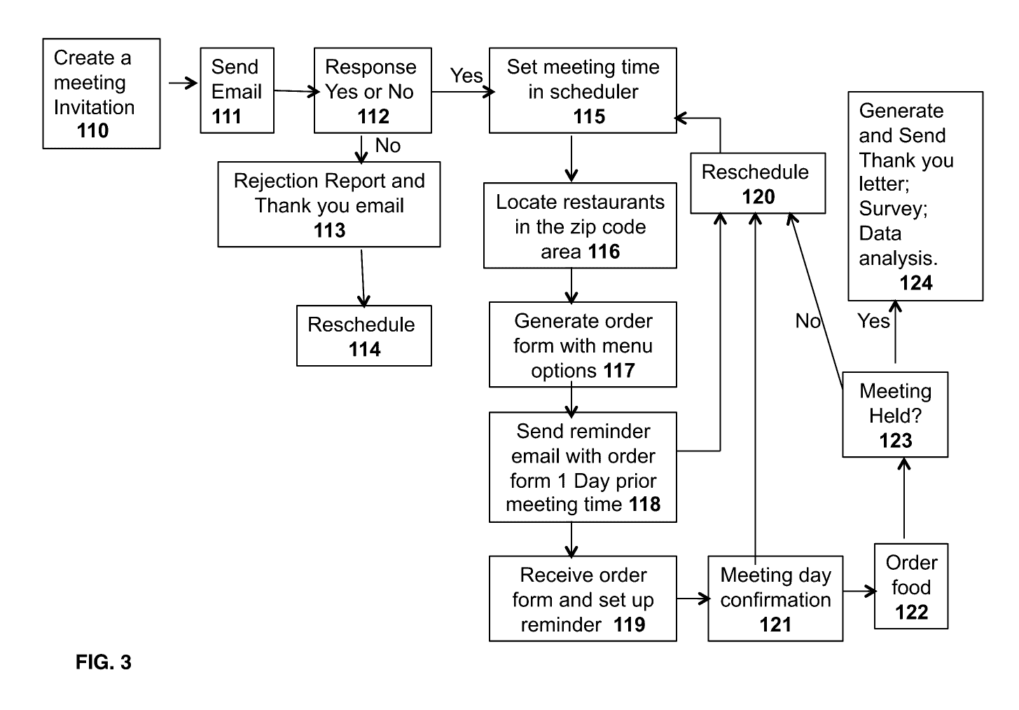

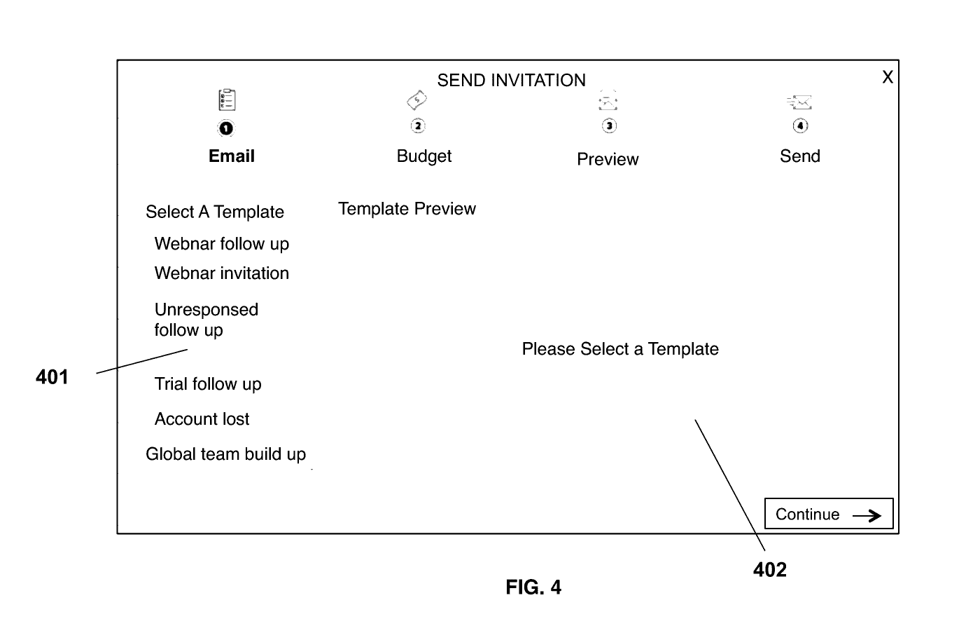

More specifically, as shown in FIG. 3, the user (sales agent) creates a virtual meeting opportunity on the system and composes an invitation email and forms 110 comprising a project name, host name, invitee, subject, a quick response link and a description of the meeting that provides free lunch or dinner, which significantly increases the acceptance rate of the invitation and reduces the no-show rate of the meeting. This invitation email is composed from selected templates 401 as shown in FIG. 4. The user selects the “invitation” tab in the top menu of the system, selects a desired template and previews it in the Preview window 402. Then the user proceeds to fill out the template with current sales information and continues to send the invitation to the client 111. If the client's response 112 is negative, the system generates a rejection report in the database and sends the client a Thank-you email 113 comprising a link for rescheduling the meeting 114. If the client accepts the initial invitation, the system sets the meeting time via a scheduler software or website 115. The system then locates restaurants within a designated area, for example, but not limited to, a zip code area, 116 and generates an order form with menu options 117. A reminder email with the order form is sent to the client one day prior to the meeting 118. A filled out order form is received by the system and a reminder for the meeting time is set 119. At the day of meeting, the system confirms with the client again via email or automated phone call 121. Once it is confirmed, the food order is placed 122. During the whole process, whenever the client decides not to attend the meeting, the system can automatically send requests to the client for a date to reschedule 120. After the meeting 123, a Thank-you letter along with an optional survey is generated and sent to the client. Data analysis along with a meeting report is conducted 124.

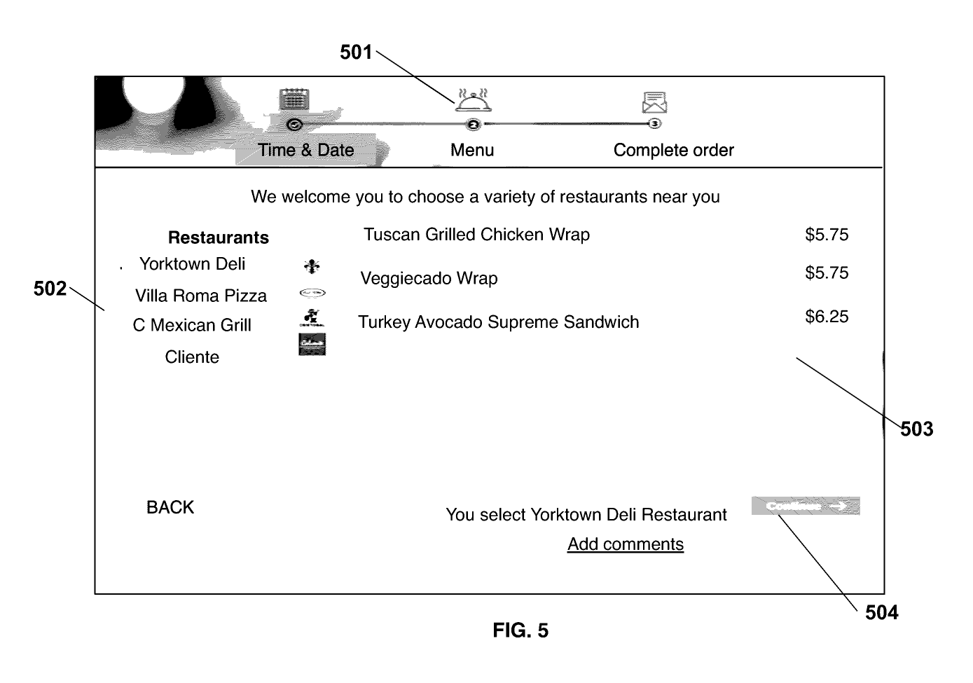

FIG. 5 shows an example of the user interface for ordering food. The icons 501 on top of the screen shows the progress of ordering food. The left column 502 in the screen shows the restaurant options located by the system. By selecting one of these restaurants, the column on the right 503 displays the food/drink menus for the selected restaurant. The user clicks the “Continue” 504 button to complete the order form.

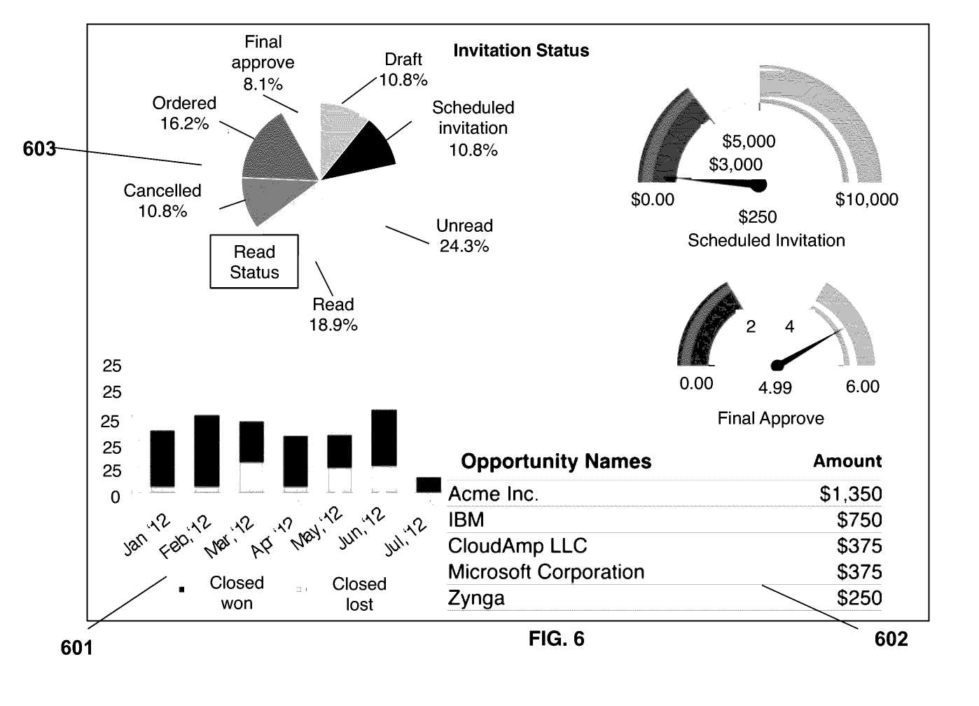

FIG. 6 shows an example of the result of data analysis. A bar chart 601 is displayed to show the total virtual business meetings conducted for the last 7 months and the ratio of closed won deals and closed lost deals after the meeting. A table 602 is displayed for logging the deals from each opportunity such as company names and values of the deals. A pie chart 603 is used for the statistics of all the generated meeting invitations, including percentages for read invitations, unread invitations, scheduled meetings, cancelled meetings, draft, final approved meetings, and meetings with ordered food. The user can monitor the over all status of all the invitations via this pie chart.

The following example is given for the purpose of illustrating various embodiments of the invention and are not meant to limit the present invention in any fashion.

### Example 1

### The System Increases the Sales Success Rate

To determine whether the system can increase prospect engagement and webinar attendance through incentives, a hundred webinar invitations were sent via email where half contained a promotional coupon code, such as for a coffee or food item. The invitation acceptance rate, meeting turn-up rate and final sales success rate are calculated throughout the whole sales process. Table 1 compares the acceptance and participating rates between the no promotion and promotion groups.

TABLE 1

| | No Promotion | Promotion |
|---|---|---|
| Invitations Sent | 50 | 50 |
| Responses Received | 2 | 18 |
| Participated in Webinar | 0 | 12 |

Statistically, the results in Table 1 show that the prospect engagement rate is about 36% for the promotion group compared to about 0.04% for the no promotion group. A significant increase in the show rate at the webinar from 0% for the no promotion group to about 67% for the promotion group is demonstrated.

In Table 2 a comparison is made between market average values and projected performance improvement utilizing the interactive tool/system for opportunity engagement for sales meetings.

TABLE 2

| | Market Avg | With the System |
|---|---|---|
| Prospect Engagement | 5%-10% | 30%-50% |
| Pipeline accurate measurement | No alternative | 90%-95% |
| No Show Rate | 40%-60% | 0%-5% |

The results also indicate that the present system significantly reduces prospects no-show rate after acceptance of the invitations. Sales opportunities engagement/Prospect engagement shows a 30%-50% response rate (positive or negative) versus the 5% to 10% market average rate. It is contemplated that a 5%-10% error margin in the pipeline accurate measurement due to email delivery statistics. A measuring assumption is made that if a prospect did not reply to an invitation, the prospect does not represent a valid business opportunity. Compared to the market average no show rate of about 40%-60%, the system is able to reduce the no show rate to about 5% or less for positive responses. This system significantly increases the sales agents work efficiency in terms of conducting virtual sales meetings, and potentially boosts the sales volume for the sales companies.

The present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention.

What is claimed is:

1. A system for a virtual breakfast, lunch or dinner business meeting, comprising:
one or more computers having at least a processor, a memory and a display coupled to the processor and at least one network connection;
an interactive tool coupled to said one or more computers comprising:
a locating tool for extracting information of restaurants and menus thereof in an area;
a plurality of modules configured to process and track information for setting up a virtual meeting, processing food orders and generating reminders;
a database for lead and sales information accessible via said modules; and
a user interface integrated in said one or more computers coupled to said modules and databases.

2. The system of claim 1, wherein said computer is a personal computer, a server computer, a smart phone, a tablet computer or any personal device with connection to a database.

3. The system of claim 1, wherein said interactive tool is further configured to generate and to send customized email invitation and information forms to clients.

4. The system of claim 1, wherein the interactive tool modules are configured to:
create a customized email invitation comprising a description of a lunch or dinner meeting with paid-for food and information forms based on a template tangibly stored in said interactive tool modules configured to increase an acceptance rate of said invitation;
send said customized email invitation and information forms to at least one potential client;
store sales information for rejected and accepted email invitations in a report for invitation results;
send a thank-you email comprising links for rescheduling said meeting to a client that rejects said invitation email;
locate restaurant menus in an area of a client that accepts said email invitation;
generate a menu option form for the meeting for a client that accepts said email invitation;
process information for a meeting time;
set up reminders for said meeting with said client that accepts the email invitation;
send meeting reminder to said client;
track a response to the meeting reminder;
order food on the ordering form if the response to the meeting reminder is positive;
send thank-you letter after the meeting;
generate logs for food orders and meeting summary in the database;
reschedule the meeting if the response to the meeting reminder is negative; and
synchronize the sales information between the computers.

5. The system of claim 4, wherein the interactive tool modules are further configured to generate a survey form for the client and collect completed survey form.

6. The system of claim 4, wherein the interactive tool modules are further configured to enter and sort the sales information and meeting information in said database.

7. The system of claim 4, wherein the interactive tool modules are further configured to analyze the sales information and predict a sales cycle for each sales lead.

8. The system of claim 4, wherein the interactive tool modules are further configured for a user to search the database for said sales information.

9. The system of claim 1, wherein said sales information comprises location, type of sales, client information, meeting report for each sales or a combination thereof.

10. The system of claim 1, wherein said interactive tool comprises:
a set of best practices module configured to access meeting invitation templates, follow up templates, reminder templates and alert templates;
a search module configured to locate sales information from said database;
a schedule module configured to schedule meetings and book time, and create reminders therefor;
a report module configured to generate a report for each meeting and overview of sales information;
a menu searching module configured for a user to collect information of restaurant menus in a designated area;
a food ordering module configured to place food order for a user and/or a client; and
a transaction module configured to deposit and spend credits in the system for food ordering.

11. The system of claim 10, wherein said user interactive tool further comprises a recording module configured to record said meeting.

12. The system of claim 10, wherein said interactive tool further comprises a data analysis module configured for users to conduct a quantitative analysis on sales information and meeting expense, and to predict a sales cycle for each sales lead.

13. A method for increasing an acceptance rate of invitations to a virtual business meeting, comprising the steps of:
accessing the system of claim 1;
generating via said system an initial email invitation to one or more prospective clients comprising:
a proposed date and time for the virtual business meeting;
a description of food available during said meeting at no cost to the client; and
a quick response link;
sending said initial email invitation to the one or more prospective clients; and
resending the email invitation with a rescheduled date and time for rescheduling the meeting if said initial invitation is declined.

14. The method of claim 13, wherein the step of generating an initial email invitation comprises:
user-searching the database for sales information or a sales lead that meets a set of criteria; and
producing the email invitation for the virtual meeting based on a selected sales lead or sales information.

15. A method for reducing a non-participation rate in a virtual business meeting after acceptance of an invitation to attend, comprising the steps of:
accessing the system of claim 1;
receiving from one or more prospective clients or invitees an acceptance of an initial email invitation comprising:
a proposed date and time for the virtual business meeting;
a description of food available during said meeting at no cost to the client; and
a quick response link;
sending a food order form or link to each of said clients after receiving the acceptance;
sending a final reminder email comprising:
a food order from said client;
a delivery location;
a meeting time; and
a quick response button or link for final confirmation of attendance before placing the food order;
ordering the food on the order form for delivery for said meeting after the client confirms attendance at the meeting no later than the morning of the meeting day; and
launching said virtual business meeting.

16. The method of claim 15, further comprising:
processing a transaction for the food order;
depositing available credit for the food order; and
generating a log for transactions.

17. A user-implemented method for conducting a virtual breakfast, lunch or dinner business meeting with a client, comprising the steps of:
implementing the interactive tool comprising the system of claim 1;
contacting one or more clients to schedule an online meeting;
ordering food online for delivery to the client prior to a scheduled meeting time if a final reminder email before the meeting is accepted; and
launching the online sales lunch or dinner meeting.

18. The user-implemented method of claim 17, further comprising:
generating a report for said meeting;
performing data analysis on the sales information related to said meeting; and
generating one or more follow-up emails to the client from a set of templates for setting up follow-up activity for the sales lead.

19. The user-implemented method of claim 18, wherein said follow up email comprises a follow-up to the client for a re-meeting, for reminding a sales agent to follow-up with the client, or a combination thereof.

20. The user-implemented method of claim 17, further comprising recording said virtual business meeting.

21. The user-implemented method of claim 17, further comprising:
rescheduling the virtual business meeting if the client is unable to meet at the scheduled time.

22. The user-implemented method of claim 17, further comprising predicting a sales cycle for the sales lead related to the virtual business meeting based on said data analysis.

23. The user-implemented method of claim 17, further comprising synchronizing the sales information between computers.

24. The user-implemented method of claim 17, wherein the step of contacting the client comprises:
user-searching the database for sales information or a sales lead that meets a set of criteria;
generating an email invitation for a virtual business meeting based on a selected sales lead or sales information;
sending a final reminder email to said client before a scheduled meeting time;
rescheduling the meeting if the reminder email is declined by the client.

25. The user-implemented method of claim 24, wherein said email invitation comprises:
a link for a quick response for said client;
a description of a free lunch or dinner meeting for the client configured to increase an acceptance rate and reducing an no show rate for the meeting; and
a link for scheduling a meeting time.

26. The user-implemented method of claim 17, wherein the step of ordering the food delivery comprises:
locating restaurant menus within a designated area for the user and the client if the email invitation is accepted;
generating an ordering form of selected restaurants for said client;
receiving the order form from said client; and
ordering food on the order form for the virtual meeting if the client confirms attendance via the final reminder email.

27. The user-implemented method of claim 26, further comprising:
processing a transaction for food orders;
depositing available credit for food orders; and
generating a log for transactions.

28. The user-implemented method of claim 26, wherein the step of locating restaurant menus comprises:
conducting a search for restaurant menus using a third-party software or website; and
extracting restaurant menus from search results of said third-party software or website.

29. A non-transitory machine-readable storage medium comprising processor executable instructions for performing the user-implemented method of claim 17.
